(19) United States
(12) Patent Application Publication
(10) Pub. No.: US 2009/0100362 A1
(43) Pub. Date: Apr. 16, 2009

(54) TEMPLATE BASED METHOD FOR CREATING VIDEO ADVERTISEMENTS

(75) Inventors: Aaron Sauve, Seattle, WA (US); Mike Van Flandern, Seattle, WA (US); Eddie Fusaro, Sammamish, WA (US); John Elsbree, Bellevue, WA (US); Chris Meyer, Redmond, WA (US); Daniel L. Poling, JR., Woodinville, WA (US); Will Vong, Huntspoint, WA (US); Marc Oshiro, Seattle, WA (US); Gary Hebert, Snohomish, WA (US); David Gardner, Covington, WA (US); Robert Thrasher, Sammamish, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/047,240

(22) Filed: Mar. 12, 2008

Related U.S. Application Data
(60) Provisional application No. 60/979,048, filed on Oct. 10, 2007.

(51) Int. Cl. G06F 3/048

(52) U.S. Cl. 715/765

(57) ABSTRACT

A method and system are disclosed for allowing an advertiser or other user to create high-end advertisements via a plurality of software-based, predefined templates. The templates may be customized by a user to configure the appearance, flow, interactivity and other features of an advertisement. The present system further provides a user interface allowing a user to interact with and configure the templates, thus allowing the user to control the appearance, flow, interactivity, transitions, timers, etc. of the advertisement. In addition to controlling these parameters, the templates also allow a user to associate one or more content files, or assets, with an advertisement. Thus, an advertiser may easily incorporate a video or other content into an advertisement.

### CROSS REFERENCE TO RELATED APPLICATION

The present application claims priority to U.S. Provisional Patent Application No. 60/979,048, by Sauve et al., entitled TEMPLATE BASED METHOD FOR CREATING VIDEO ADVERTISEMENTS, filed Oct. 10, 2007, which application is incorporated by reference herein in its entirety.

### BACKGROUND

A fundamental aspect of free content delivery, such as for example over the Internet, is the ability of a sponsor to provide advertising along with content desired by an end user. The revenue generated by advertisers often allows a content provider to provide content without requiring subscription fees from users. In exchange for free content delivery, users either view advertisements along side their desired content, or view an advertisement before their content is delivered.

Video advertisements typically have a greater impact on viewers than traditional static and text-based advertisements. However, the current process for creating a high-end, polished video advertisement is complicated and time consuming for advertising agencies and video designers. It would be advantageous for advertising agencies and video designers to have simplified tools for creating high-end video advertisements. Moreover, typical advertisers do not have the know-how or tools to create a high-end video advertisement. If advertisers had simplified tools for creating high-end video advertisements, they may be able to create these advertisements without the added time and expense of having to hire an outside agency or designer to create the advertisement.

### SUMMARY

Embodiments of the present system allow an advertiser or other user of the present system to create high end advertisements, for example including a Flash® video or other video. The present system employs a plurality of software-based, predefined templates which a user may employ to configure the appearance, flow, interactivity and other features of an advertisement. Thus, an advertiser with little or no coding experience may select one or more predefined templates and, using the template(s), the advertiser may create a high-end, interactive advertisement including high end video, graphics and other media.

The templates may for example be markup language software templates which the advertiser can use to create an interactive video advertisement. The language may for example be XML, MCML (Media Center Markup Language) or other known markup languages. The present system may further provide a graphical interface with which the user may interact in order to create an advertisement. The user interface may present a user with template default values that set the appearance, flow, interactivity, transitions, timers, etc. of the advertisement. If the advertiser wants more of a custom look and feel to the advertisement, they can choose to override the default values. In addition to controlling these parameters, the templates also allow a user to associate one or more content files, or assets, with an advertisement. Thus, an advertiser may easily incorporate a video or other content into an advertisement.

Moreover, the template allows a user to control the interactivity with an advertisement. For example, the templates may allow an advertiser to include a “learn more” option within an advertisement. The advertiser could associate a wide variety of assets with an advertisement so that, if a viewer selects the “learn more option,” the viewer may be provided with a menu driven interface through which a viewer can access as much or as little additional information as desired.

Typically, advertisers require viewers to sit through at least a given amount of an advertisement. In order to provide greater end-user control of the experience, embodiments of the present system employ countdown timers showing how much time remains in the advertisement. Embodiments also provide seamless flow-through, so that when the timer has expired, the original content of interest to the viewer may automatically run. Embodiments may further provide the ability to skip out of a longer ad after watching only a portion of it.

### BRIEF DESCRIPTION OF THE DRAWINGS

FIG. 1 is an exemplary functional block diagram of components of a computing environment for executing the present system.

FIGS. 2-6 are exemplary screenshots obtained by the method of the present system.

### DETAILED DESCRIPTION

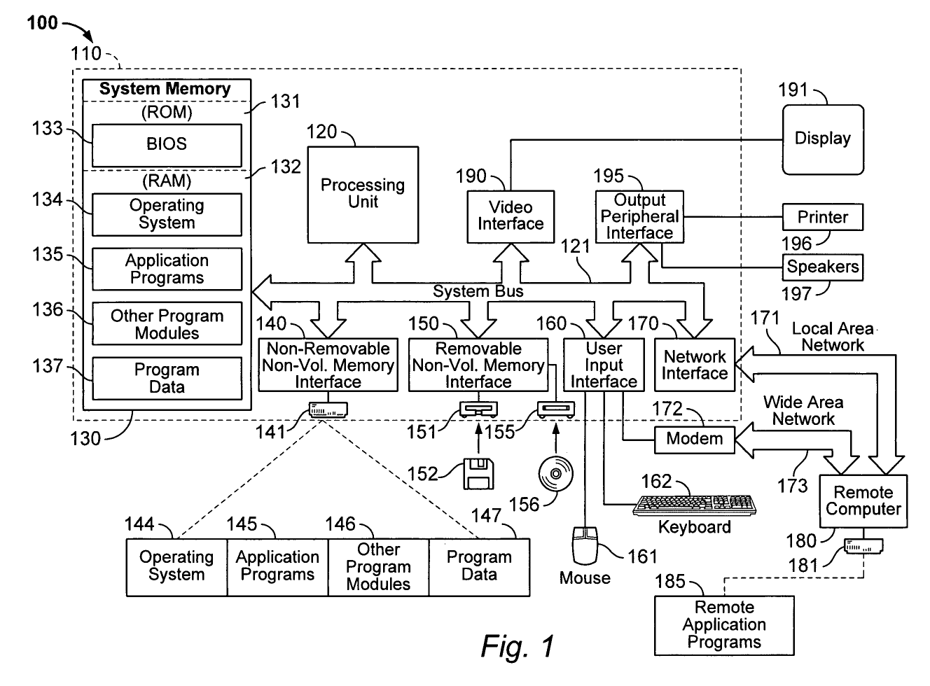

Embodiments of the invention will now be described with reference to FIGS. 1-6, which in general relate to template based methods for creating video advertisements. The methods described herein can be performed on a variety of processing systems. FIG. 1 illustrates an example of a suitable general computing system environment 100 on which the invention may be implemented. The computing system environment 100 is only one example of a suitable computing environment and is not intended to suggest any limitation as to the scope of use or functionality of the invention. Neither should the computing system environment 100 be interpreted as having any dependency or requirement relating to any one or combination of components illustrated in the exemplary computing system environment 100.

The invention is operational with numerous other general purpose or special purpose computing systems, environments or configurations. Examples of well known computing systems, environments and/or configurations that may be suitable for use with the invention include, but are not limited to, personal computers, server computers, multiprocessor systems, microprocessor-based systems, set top boxes, programmable consumer electronics, network PCs, minicomputers, mainframe computers, laptop and palm computers, hand held devices, gaming systems such as the Xbox® gaming system, smart phones, television connected devices, and distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communication network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVDs) or other optical disk storage, magnetic cassettes, magnetic tapes, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, DVDs, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communication over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

A template based method of creating interactive advertisements may be used with a computing environment as described above. In general, the template based method of creating interactive advertisements allows an advertiser with little or no coding experience to select one or more predefined templates and, using the template(s), the advertiser may create an interactive video advertisement. With a template based model of creating video advertisements, much of the hard work is done for the advertiser. Accessibility, transitions, timers, flow, etc. would all be handled by the templates with smart default values. If the advertiser wants more of a custom look and feel, they can choose to override the default values.

The templates may be markup language software templates which the advertiser can interact with to create an interactive video advertisement. The language may for example be XML, MCML or other known markup languages. Using this model, the content, or assets, provided by the advertiser may be separated from the code and markup to display those assets. This enables a solution that works cross platform. Once an ad is sold the ad can be shown on any platform that supports the template that the ad uses. Thus, even though a media platform may not run Flash® media, the interactive ads created by the template method of the present system will operate on that platform. Similarly, the Microsoft XBox® media and gaming system may have its platform restrictions. The interactive ads created by the template method of the present system will also operate on the XBox platform.

A template in general may define a high level look and feel to an advertisement. Once an advertiser selects a particular template having the look and feel the advertiser desires, the advertiser works with the template using a graphical user interface tool (described hereinafter) to add additional content, or assets, to the video advertisement. The templates may prompt and/or allow an advertiser to specify parameters including text labels, color, fonts, sounds, images, videos, layout choices, animation choices, timeouts, counts, etc. Variable-length lists may be formed for any of the above. The templates include design elements such as a timer and “learn more” options as explained below.

The template may also allow advertisers to add interactive properties to advertisements. For example, an advertisement may include a “learn more” button, which when accessed, presents the user with any manner of additional content which would be specified by the advertiser via the selected template or templates. For example, upon accessing the “learn more” button, the user may be provided with a menu. An advertiser may add assets relating to lists that would populate these menu items. The “learn more” button may also run a more in-depth video clip which would be provided by the advertiser via the template. In alternative embodiments, the “learn more” option and other interactivity options may be omitted from the templates.

In embodiments, the content or assets may be provided in an “ad asset manifest” in an XML file, which will represent all of the assets associated with their advertisement. This XML includes links to all the relevant assets to the ad, and various associated parameters. It also refers to the template ID, such as for example: 8a5d134e-2384-40a4-9884-d638f609b4e1. This template ID would specify how the above assets would be laid out, and all the interactivity related to these assets.

Typically, in order to provide free content, a content provider will force end-users to sit through one or more advertisements. In order to provide greater end-user control of the experience, embodiments of the present system employ countdown timers showing how much time remains in the advertisement. Embodiments also provide seamless flow-through, so that when the timer has expired, the original content of interest to the user may automatically run. However, in embodiments, advertisers may omit the automatic flow-through so that a viewer must interact with the advertisement in order to end the advertisement and receive the requested content. Embodiments may further provide the ability to skip out of a longer ad after watching only a portion of it.

According to embodiments of the present system, accessibility, common elements, navigation, and flow are all handled by software code, which in turn communicates with the template. The template also provides the ability to play the ad across a set of platforms/apps, both hardware, and software. The navigation elements used by the templates are consistent across the different templates.

Templates may be used together in creating an advertisement. It is possible to have a template within a template. It is also possible to string templates together to form any number of flows.

The system further includes tools for generating the XML code for specific templates, and then provides a visual interface for populating the templates. In embodiments, a tool may present an advertiser with a graphical user interface allowing a user provide the necessary and desired information to the template. In operation, an advertiser selects a template, and the tool prompts the advertiser for assets, creates the advertisement, and then provides a preview of the advertisement. For example, the tool would output an XML such as shown in the Appendix attached hereto and incorporated in its entirety herein. This XML includes links to all the relevant assets to the ad, and various associated parameters. It also refers to the template ID.

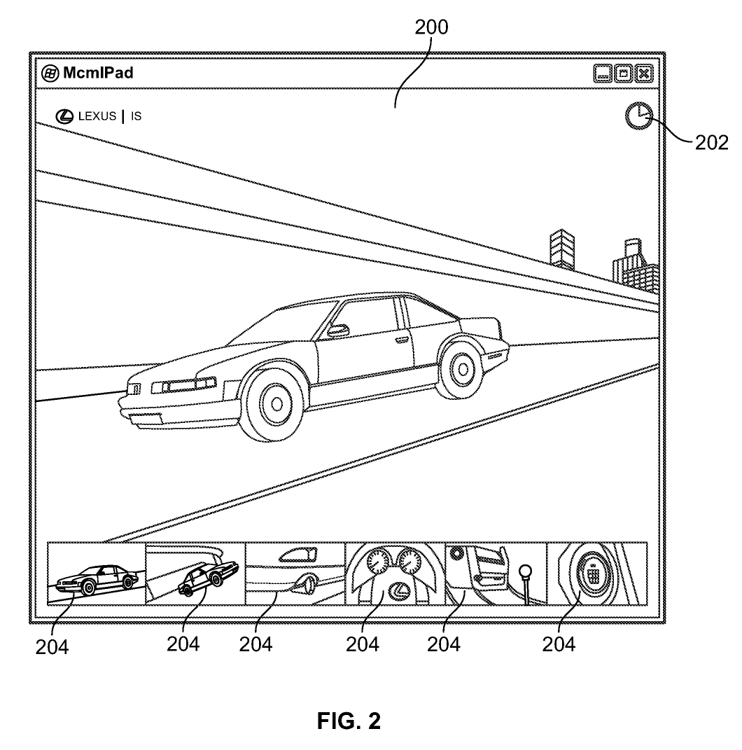

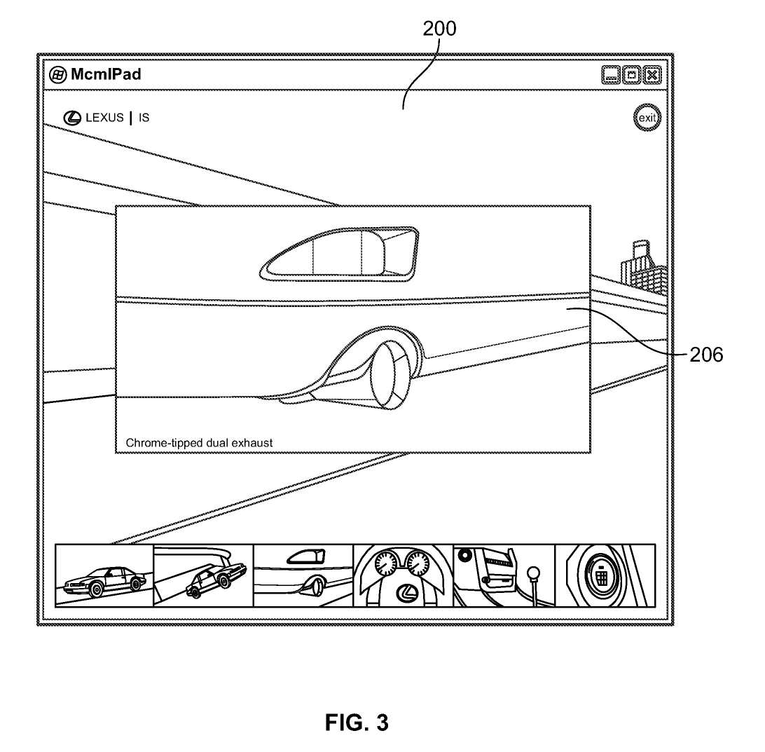

For the above XML, as shown in FIG. 2, a specific template could display a video 200 including a countdown timer 202, a background image, and 6 images 204 that can be swapped out. As shown in FIG. 3, the template may allow an advertiser to specify that, when one of the images 204 is selected by the end-user, a larger graphic of the image 206 may be displayed over the video.

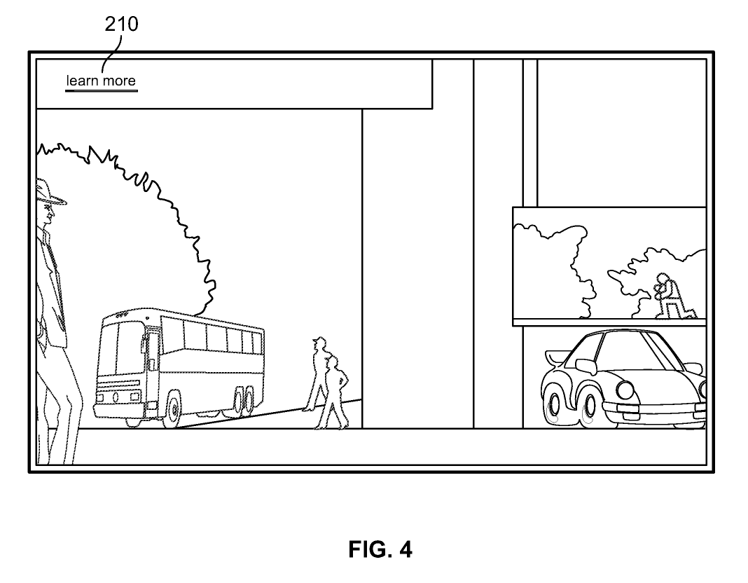

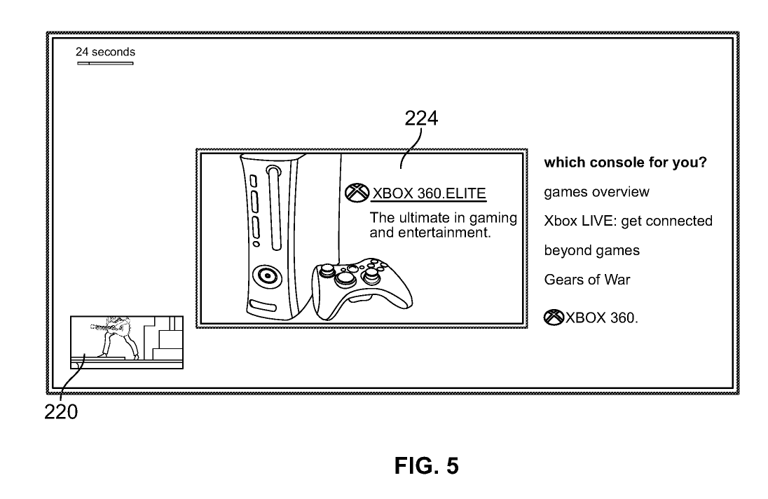

FIG. 4 is a screenshot from a video advertisement created by a template showing an example of a “Learn More” element 210. When this element is selected, the original advertisement 220 may minimize to a corner of the display, such as to the lower left hand corner of the display as shown in FIG. 5. The content 224 specified in the template upon selection of the “learn more” option may then be displayed to the end-user. The user may toggle back and forth between the original advertisement and the portion of the advertisement presented upon selection of the “learn more” option.

Each template would allow for a certain amount of flexibility. The template would have defaults for each customizable point to make it simple to start off, but many parameters can be tweaked to help support a broad array of ad look and feel. For example, the advertiser could easily set a property that would move the picture strip to the top/left/right. The advertiser could choose whether or not to have a timer, or if the strip refers to videos instead of images.

It is conceivable that the advertiser could be allowed a vast array of customization options in addition to simply selecting which template to use. Examples include:
Location for each element
Presence for each element
Video length, timer length
Items referenced for each element
Animations for each element
Select behavior for each element
Color/font/border style for each element
Ability to navigate to another template, or host a template within a template
Flow of the template
Whether or not videos play full screen.

The templates offer a consistent user experience. In order to preserve a usable experience, certain restrictions could be enforced on each template. Examples include:
Max length of timer
Common and consistent navigation elements
Entry point to another template might be held consistent
Aspects of timer look and feel
Ability to get back to the video
Accessibility
Max number of templates that can be strung together.

The tool for use with the present system would allow the advertiser to choose a template. Then the tool would present an aid to help the advertiser select the appropriate assets to build that template. The output of this tool would be the “ad asset manifest” XML file (similar to the example above) which would be properly constructed and would link to all the assets. The tool would include a link to preview the ad. Once the manifest has been authored to include links to all the related assets, any application that supports template based ads could display the ad.

There are certain behavior points that are related to the present system. The templates of the present system provide giving viewers the best of TV and internet ads by allowing a flow-through model with the ability to interact. A further feature is the ability to telescope out to a landing page and automatically send the end user back to the end-user's content without requiring user navigation. A further feature is the ability to provide a longer ad with an option to leave the ad after only a portion of it is displayed so that the end-user can return to his or her desired content. For instance, an ad may be 60 seconds long, but the end-user may be provided with the option to skip the ad after 30 seconds.

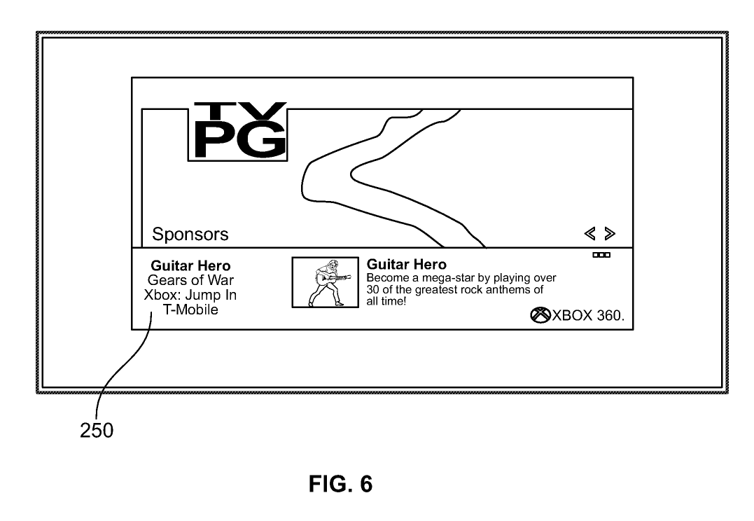

A further feature is the ability to get back to any ad within a content set, as shown in the screenshot in FIG. 6. As shown therein, with a click of the remote control, a user has the ability to get back to any of the ads 250 in a segment. This means that although the user might have already seen the ad, they are always at the user's fingertips.

Template based ads will be fully instrumented. Clicks will be associated with each element, and reported for tracking purposes, and time spent in each template will also be measured. The time when a user interacts with the ad will also be recorded.

The present system provides several benefits for advertisers. Advertisers only have to select a template, hand off the assets, and they can have the following:
Interactivity injected in-line with all flow and navigation handled
Accessible navigation elements
No functionality testing required (only preview is needed)
Cross-platform presentation
Consistent user experience
Built in reporting
No need to focus on peripheral elements—they can focus on their own brand assets only if they desire.

Moreover, users can have an experience that can be controlled by the keyboard, mouse, touch, or a remote control depending on the environment that happens to support the template based ad.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method for allowing the creation of an advertisement, comprising the steps of:
(a) generating a plurality of software-based templates;
(b) presenting a graphical user interface over a display allowing a user to select one or more of the software-based templates; and
(c) presenting a graphical user interface over a display allowing a user to interact with the one or more software-based templates selected in said step (b) to add one or more assets for display in the advertisement and to determine at least one the appearance, flow, interactivity, transitions, and a minimum length of time for the advertisement.

2. The computer implemented method of claim 1, wherein said step (c) of presenting a graphical user interface over a display allowing a user to interact with the one or more software-based templates comprises the step of providing the user with default settings for selecting at least one of the appearance, flow, interactivity, transitions, and a minimum length of time for the advertisement.

3. The computer implemented method of claim 2, wherein said step (c) of presenting a graphical user interface over a display allowing a user to interact with the one or more software-based templates comprises the step of allowing a user to change the default settings in order to select at least one of the appearance, flow, interactivity, transitions, and a minimum length of time for the advertisement.

4. The computer implemented method of claim 1, wherein said step (a) of generating a plurality of software-based templates comprises the step of generating a plurality of templates using a markup language.

5. The computer implemented method of claim 1, wherein said step (c) of presenting a graphical user interface over a display allowing a user to interact with the one or more software-based templates comprises the step of allowing a user to interact with the one or more software-based templates to determine each of the appearance, flow, interactivity, transitions, and a minimum length of time for the advertisement.

6. The computer implemented method of claim 1, wherein said step (c) of presenting a graphical user interface over a display allowing a user to interact with the one or more software-based templates for selecting appearance of an advertisement comprises the step of allowing a user to specify parameters including text labels, color, fonts, sounds, images, videos, layout choices, animation choices, timeouts and counts.

7. The computer implemented method of claim 1, wherein said step (c) of presenting a graphical user interface over a display allowing a user to determine interactivity comprises the step of allowing a user to add an option which, if selected by the user, presents additional content to the user, the additional content being defined by the one or more assets added in said step (c).

8. The computer implemented method of claim 1, further comprising the step (d) of providing a seamless flow-through upon completion of the advertisement to viewer-selected content without user interaction.

9. A computer implemented method for allowing the creation of an advertisement, comprising the steps of:
(a) generating a plurality of software-based templates, the plurality of software-based templates specifying how one or more assets are presented in the advertisement, specifying interactivity with the one or more assets, and specifying a minimum amount of time an advertisement runs for; and
(b) presenting a graphical user interface over a display allowing a user to select one or more of the software-based templates, allowing the user to add the one or more assets to be used by the one or more templates per step (a), and allowing a user to configure the one or more templates to customize the advertisement.

10. The computer implemented method recited in claim 9, said step (b) of presenting a graphical user interface over a display allowing a user to select one or more of the software-based templates comprising the step of allowing a user to select a string of templates to be used together.

11. The computer implemented method recited in claim 9, said step (b) of presenting a graphical user interface over a display allowing a user to select one or more of the software-based templates comprising the step of allowing a user to select a first template to be used within a second template.

12. The computer implemented method recited in claim 9, wherein said step (b) of presenting a graphical user interface over a display allowing a user to add the one or more assets comprises the step of allowing a user to add a first set of one or more assets including a video to be displayed to a viewer without viewer interaction with the advertisement.

13. The computer implemented method recited in claim 12, wherein said step (b) of presenting a graphical user interface over a display allowing a user to add the one or more assets comprises the step of allowing a user to add a second set of one or more assets to be displayed to a viewer upon the viewer interacting with the advertisement with a user selection device to indicate the viewer's desire to receive additional information.

14. The computer implemented method recited in claim 13, wherein said step (a) of generating a plurality of software-based templates specifying interactivity with the one or more assets comprises the step of allowing the user to toggle between the first set of assets and the second set of assets.

15. The computer implemented method recited in claim 9, wherein said step (b) comprises the step of presenting a graphical user interface allowing a user to configure the one or more templates to include a count down timer displayed on the advertisement.

16. The computer implemented method recited in claim 9, wherein said step (b) comprises the step of presenting a graphical user interface allowing a user to configure the one or more templates to enable a viewer to interact with the advertisement to terminate the advertisement after a preset period of time.

17. The computer implemented method recited in claim 9, wherein said step (b) comprises the step of presenting a graphical user interface allowing a user to configure the one or more templates to determine at least one the appearance, flow, interactivity, transitions, and a minimum length of time for the advertisement.

18. A computer-readable medium having computer-executable instructions for programming a processor to perform a method for allowing the creation of an advertisement, the method comprising the steps of:
(a) generating a plurality of software-based templates, the plurality of software-based templates specifying how one or more assets are presented in the advertisement, specifying interactivity with the one or more assets, and specifying one or more of one the appearance, flow, interactivity, transitions, and a minimum length of time for the advertisement; and
(b) presenting a graphical user interface over a display allowing a user to select one or more of the software-based templates, allowing the user to add the one or more assets to be used by the one or more templates per step (a), and allowing a user to configure the one or more templates to further specify the appearance, flow, interactivity and transitions of the advertisement.

19. A computer-readable medium as recited in claim 18, said step (b) of allowing a user to further specify the appearance of the advertisement comprising the step of allowing the user to further specify parameters including text labels, color, fonts, sounds, images, videos, layout choices, animation choices, timeouts and counts.

20. A computer-readable medium as recited in claim 18, further comprising the step (c) of transitioning from the advertisement to content requested by a viewer upon completion of the advertisement without interaction by the viewer with the advertisement.
